(19) United States
(12) Patent Application Publication
(10) Pub. No.: US 2025/0001781 A1
(43) Pub. Date: Jan. 2, 2025

(54) SYSTEM AND METHOD FOR PRESERVING INK IMAGE QUALITY IN AN INKJET PRINTER DURING PRINTING

(71) Applicant: Xerox Corporation, Norwalk, CT (US)

(72) Inventors: Douglas K. Herrmann, Webster, NY (US); Seemit Praharaj, Webster, NY (US); Jason M. LeFevre, Webster, NY (US); Varun Sambhy, Pittsford, NY (US)

(21) Appl. No.: 18/343,534

(22) Filed: Jun. 28, 2023

(51) Int. Cl. B41J 29/377; B41J 2/045

(52) U.S. Cl. CPC B41J 29/377; B41J 2/04566; B41J 2/04586

(57) ABSTRACT

An inkjet printer includes air baffles on opposite sides of each printhead in the process direction. The air baffle on the upstream side of the printheads directs a positive air flow toward a conveyor moving media past the printheads and the air baffle on the downstream side pulls a negative air flow on the opposite side. The positive and negative air flows produce an air flow across the nozzle plates of the printheads that sweep all of the ink drops of a sneeze pattern and satellite ink drops produced from the sneeze pattern ink drops into the air baffle pulling the negative air flow. A kit is provided to retroactively modify an existing inkjet printer to produce an air flow that sweeps the nozzle plate of a printhead between the air baffles of the kit.

### TECHNICAL FIELD

This disclosure relates generally to devices that produce ink images on media, and more particularly, to the preservation of ink image quality in such devices during printing.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content that define the images. The actuators in the printheads respond to the firing signals by expanding into an ink chamber to eject ink drops onto an image receiving surface and form an ink image that corresponds to the digital image content used to generate the firing signals. The image receiving surface is usually a continuous web of media material or a series of media sheets.

Inkjet printers used for producing color images typically include multiple printhead assemblies. Each printhead assembly includes one or more printheads that typically eject a single color of ink. In a typical inkjet color printer, four printhead assemblies are positioned in a process direction with each printhead assembly ejecting a different color of ink. The four ink colors most frequently used are cyan, magenta, yellow, and black. The common nomenclature for such printers is CMYK color printers. Some CMYK printers have two printhead assemblies that print each color of ink. The printhead assemblies that print the same color of ink are offset from each other by one-half of the distance between adjacent inkjets in the cross-process direction to double the number of pixels per inch density of a line of the color of ink ejected by the printheads in the two assemblies. As used in this document, the term “process direction” means the direction of movement of the image receiving surface as it passes the printheads in the printer and the term “cross-process direction” means a direction that is perpendicular to the process direction in the plane of the image receiving surface.

Inkjets, especially those in printheads that eject aqueous inks, need to regularly fire to help prevent the ink in the nozzles from drying. If the viscosity of the ink increases too much, the probability of an inkjet failure increases substantially. To maintain the operational status of the inkjets, each inkjet is periodically operated to eject single drops from each nozzle in some prescribed pattern onto a printed page. This pattern is designed to be below the visibility threshold of the viewer. If the pattern is too dense, the customer finds the print objectionable, if the pattern is not dense enough, the firing frequency of the inkjets may be insufficient to maintain the operational status of the inkjets. This method of inkjet maintenance conducted during printing is typically referred to as “sneezing” or “background jetting.” Typically, sneezing operations are performed during the printing of each page in a print job. As used in this document, the term “sneeze operation” means applying firing signals to inkjets to eject ink drops for the purpose of preventing ink from drying in inkjet nozzles and not for the purpose of forming an ink image.

The ink that is ejected during sneezing operations is deposited directly in the image and this is acceptable to most casual observers and printer users. However, when higher image quality is required, the sparsely distributed ink drops can be detected in the image. For example, image quality is degraded when the images require photo quality or when a page has very little image printed on it. The extraneous sneeze drops are especially noticeable in lighter regions or where the media is white with no image printed in the white region. Inkjet printers would benefit from performing sneeze operations during the printing of high quality images or the printing of images with sparse content without adversely impacting image quality.

### SUMMARY

A color inkjet printer is configured to maintain sneeze operations during the printing of high quality images or the printing of images with sparse content without adversely impacting image quality. The color inkjet printer includes at least one printhead configured to eject drops of ink, a conveyor configured to move media past the at least one printhead to receive ink drops ejected from the at least one printhead, a first housing positioned on one side of the at least one printhead in a process direction, the first housing have a first opening and a second opening, a second housing positioned on an opposite side of the at least one printhead in the process direction, the second housing have a first opening and a second opening, a positive air flow source pneumatically coupled to the first opening of the first housing, and a negative air flow source pneumatically coupled to the first opening of the second housing.

A method of operating a color inkjet printer maintains sneeze operations during the printing of high quality images or the printing of images with sparse content without adversely impacting image quality. The method includes directing a positive air flow toward a conveyor moving media past at least one printhead in the inkjet printer, the positive air flow being on a first side of the at least one printhead in a process direction and pulling a negative air flow across a nozzle plate of the at least one printhead in the inkjet printer, the negative air flow being on a second side of the at least one printhead in the process direction that is opposite the first side of the printhead in the process direction.

A kit retroactively modifies an inkjet printer to sweep a nozzle plate of a printhead in the inkjet printer during sneeze operations. The kit includes a first air baffle, a second air baffle, a clip configured to hold the first air baffle and the second air baffle against opposite sides of a printhead in the inkjet printer, a positive air flow source configured to be pneumatically coupled to the first air baffle, and a negative air flow source configured to be pneumatically coupled to the second air baffle.

### BRIEF DESCRIPTION OF THE DRAWINGS

The foregoing aspects and other features of a color inkjet printer and color inkjet printer operational method that maintains sneeze operations during the printing of high quality images or the printing of images with sparse content without adversely impacting image quality are explained in the following description, taken in connection with the accompanying drawings.

FIG. 1 is a schematic drawing of a color inkjet printer that maintain sneeze operations during the printing of high quality images or the printing of images with sparse content without adversely impacting image quality.

FIG. 2 depicts the print zone of the printer shown in FIG. 1.

FIG. 3 shows an air baffle system that can be added to a printhead in the printer of FIG. 1.

FIG. 4 shows the addition of an air baffle system to each printhead in a printhead assembly of the printer shown in FIG. 1.

FIG. 5 is a side view of a printhead and the air baffles held against each side of the printhead.

FIG. 6 is a flow diagram for operating the printer of FIG. 1.

### DETAILED DESCRIPTION

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

The printer and method described below use a positive flow of air across a printhead nozzle plate in the process direction to sweep all of the sneeze ink drops and the satellite ink drops produced from the sneeze ink drops into an air baffle pulling a negative flow of air to prevent the ink drops from reaching media passing the printhead. The sneeze operation is performed on a periodic basis while image printing is paused so the media passing the printhead does not receive ink and can be later used in another print job. To further enhance the breakup of the sneeze drops so they are swept into the negative air flow baffle more efficiently, the printhead is vertically raised away from the media path by some predetermined distance. Additionally, a humidifier can be used to install water or solvent vapor into the positive air flow to attenuate ink drying in the nozzles of the printhead and a filter can be placed in the negative air flow to remove ink from the air flow.

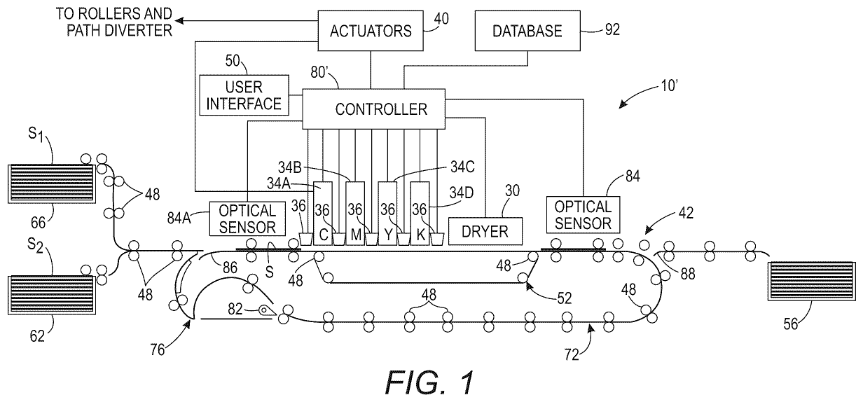

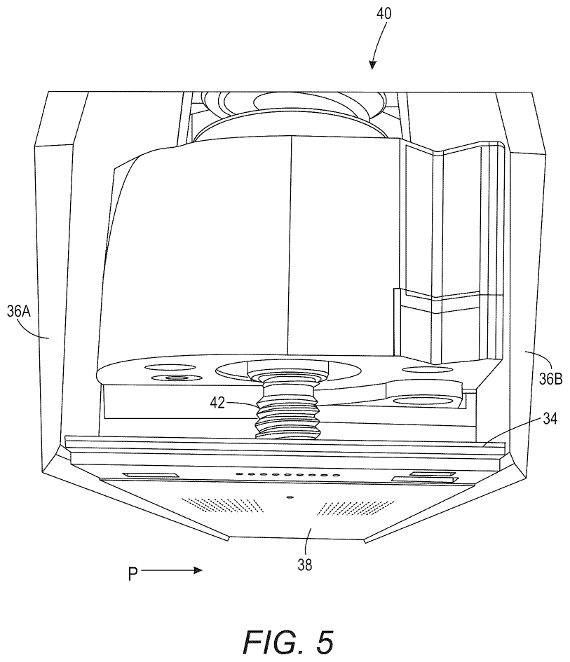

FIG. 1 depicts a high-speed color inkjet printer 10 that prevents sneeze drops from reaching media. As illustrated, the printer 10 is a printer that directly forms an ink image on a surface of a media sheet stripped from one of the supplies of media sheets S₁ or S₂ and the sheets S are moved through the printer 10 by the controller 80 operating one or more of the actuators 40 that are operatively connected to rollers or to at least one driving roller of conveyor 52 that comprise a portion of the media transport 42 that passes through the print zone PZ (shown in FIG. 5) of the printer. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads that enables media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

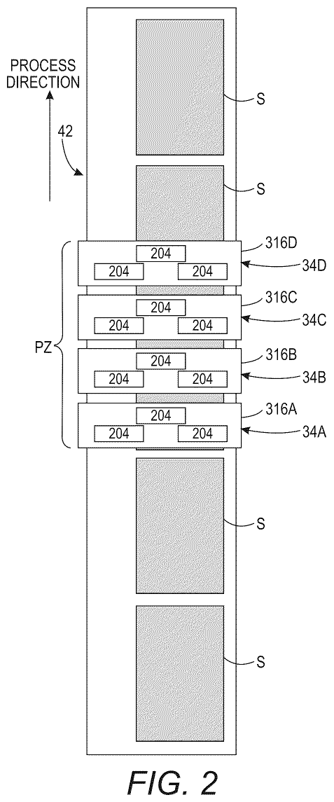

The print zone PZ in the prior art printer 10 of FIG. 1 is shown in FIG. 2. The print zone PZ has a length in the process direction commensurate with the distance from the first inkjets that a sheet passes in the process direction to the last inkjets that a sheet passes in the process direction and it has a width that is the maximum distance between the most outboard inkjets on opposite sides of the print zone that are directly across from one another in the cross-process direction. Each printhead module 34A, 34B, 34C, and 34D shown in FIG. 2 has three printheads 204 mounted to one of the printhead carrier plates 316A. 316B, 316C, and 316D, respectively.

As shown in FIG. 1, the printed image passes under an image dryer 30 after the ink image is printed on a sheet S. The image dryer 30 can include an infrared heater, a heated air blower, air returns, or combinations of these components to heat the ink image and at least partially fix an image to the web. An infrared heater applies infrared heat to the printed image on the surface of the web to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer.

A return path 72 is provided to receive a sheet from the media transport 42 after a substrate has been completely or partially printed and passed through the dryer 30. The sheet is moved by the rotation of rollers in the return path 72 in a direction opposite to the direction of movement in the process direction past the printheads. An inverter 76 turns a sheet over for duplex printing if the sheet follows the rounded portion of the return path 72. If the sheet follows the straight portion of the return path 72, then the inverter is bypassed and the side of the sheet previously printed can be printed again. The controller operates an actuator 40 to move the pivoting member 82 clockwise to direct a sheet into the inverter 76 and counterclockwise to bypass the inverter. Regardless of whether the substrate is inverted or not, it merges into the job stream being carried by the media transport 42 depending on the position of pivoting member 86. Movement of pivoting member 88 provides access to the return path 72. Rotation of pivoting member 88 is controlled by controller 80 selectively operating an actuator 40 operatively connected to the pivoting member 88. When pivoting member 88 is rotated counterclockwise as shown in FIG. 1, a substrate from media transport 42 is diverted to the return path 72. Rotating the pivoting member 88 in the clockwise direction from the diverting position closes access to the return path 72 so substrates on the media transport move to the receptacle 56.

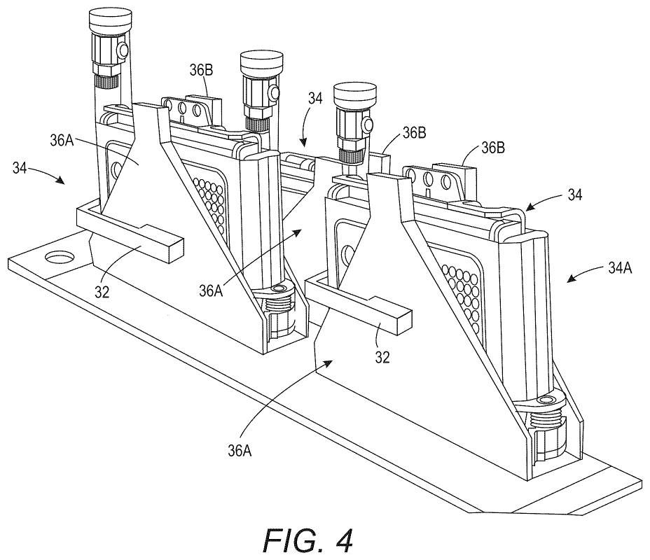

As further shown in FIG. 1, the printed media sheets S not diverted to the duplex path 72 are carried by the media transport to the sheet receptacle 56 in which they are be collected. Before the printed sheets reach the receptacle 56, they pass by an optical sensor 84B. The optical sensor 84B generates image data of the printed sheets and this image data is analyzed by the controller 80 to detect streakiness in the printed images on the media sheets of a print job. Additionally, sheets that are printed with test pattern images are inserted at intervals during the print job. These test pattern images are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the right mass or landing at an errant position is called an inoperative inkjet in this document. The controller can store data identifying the inoperative inkjets in database 92 operatively connected to the controller. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. The optical sensors 84A and 84B can be a digital camera, an array of LEDs and photodetectors, or other devices configured to generate image data of a passing surface. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. While FIG. 4 shows the printed sheets as being collected in the sheet receptacle, they can be directed to other processing stations (not shown) that perform tasks such as folding, collating, binding, and stapling of the media sheets.

Operation and control of the various subsystems, components and functions of the machine or printer 10 are performed with the aid of a controller or electronic subsystem (ESS) 80. The ESS or controller 80 is operatively connected to the components of the printhead modules 34A-34D (and thus the printheads), the actuators 40, and the dryer 30. The ESS or controller 80, for example, is a self-contained computer having a central processor unit (CPU) with electronic data storage, and a display or user interface (UI) 50. The ESS or controller 80, for example, includes a sensor input and control circuit as well as a pixel placement and control circuit. In addition, the CPU reads, captures, prepares, and manages the image data flow between image input sources, such as a scanning system or an online or a work station connection (not shown), and the printhead modules 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in memory associated with the processors or controllers. The processors, their memories, and interface circuitry configure the controllers to perform the operations described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 80 from either a scanning system or an online or work station connection for processing and generation of the printhead control signals output to the printhead modules 34A-34D. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

In further detail, FIG. 1 includes air baffles 36 that direct an air flow across the nozzle plates of a printhead during a sneeze operation so the sneeze ink drops and the satellite ink drops they produce are swept into a negative air flow baffle so the sneeze drops and satellite drops do not reach media moving past the printhead. A single baffle 36 is depicted between adjacent printheads in the print zone in order to simplify the figure; however, a positive air flow baffle and a negative air flow baffle are provided on opposite sides of each printhead in the process direction. As used in this document, the term “air baffle” means a structure that encloses a volume of air and is configured to allow air to from at least one opening in the structure at one end to at least one other opening at another end of the structure.

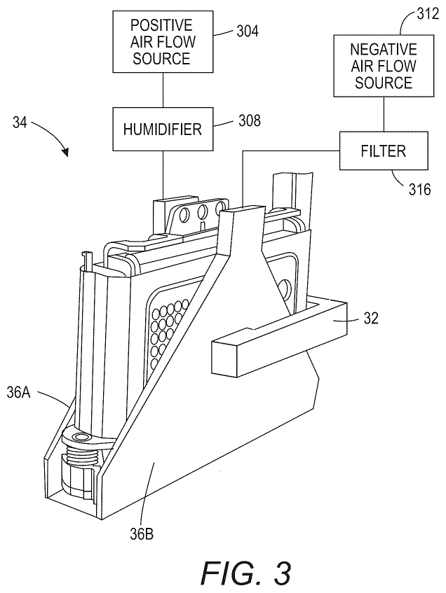

FIG. 3 shows a printhead 34 that can be installed in one of the printhead assemblies 34A to 34D. The printhead is configured with a positive air flow baffle 36A on the process direction upstream side of the printhead while a negative air flow baffle 36B is positioned on the process direction downstream side. The baffles 36A and 36B are installed by positioning a U-shaped clip 32 so the two legs of the clip urge the baffles against the printhead. Other means of securing the baffles to opposite sides of the printhead can be used. The positive air flow baffle 36A is pneumatically coupled to a positive air flow source 304. In one embodiment, the positive air flow source 304 produces air that exits the baffle at 1 meter/second. This air speed of the flow passing the nozzle plate of the printhead corresponds well with the media transport speed of 1300 mm/second in one embodiment. Of course, the speed of the exiting air can vary to correspond with the media transport speed in other printer embodiments. A humidifier 308 can be interposed in the pneumatic path between the air flow baffle 36A and the positive air flow source 304 to provide water vapor or solvent vapor to the baffle 36A. The vapor produced by the humidifier 308 helps keep ink in the nozzles in the nozzle across which an air flow from the baffle 36A moves from drying. A negative air flow source 312 is pneumatically coupled to the negative air flow baffle 36B. The negative air pressure produced by the negative air flow source 312 at the opening in the air flow baffle 36B positioned next to the printhead nozzle plate 38 helps pull the air exiting the positive air flow baffle 36A across the nozzle plate 38 and into the negative air flow baffle 36B. A filter 316 can be positioned with the pneumatic path between the exit port of baffle 36B and the negative air flow source 312 to remove aerosolized ink from the air flow. The filter is configured for installation and removal from the pneumatic path for maintenance purposes.

FIG. 4 shows an embodiment of printhead assembly 34A configured with three printheads 34 and each printhead has a positive air flow baffle 36A and a negative air flow baffle 36B. The arrow P indicates the process direction of the media that passes the printhead assembly 34A. Each positive air flow baffle 36A is coupled to at least a positive air flow source 304 and, optionally, a humidifier 308 as noted above with regard to FIG. 3. Also, each negative air flow baffle 36B is coupled to at least a negative air flow source 312 and, optionally, a filter 316 as noted above with regard to FIG. 3. The remaining printhead assemblies of FIG. 1, namely, assemblies 34B, 34C, and 34D are similarly configured.

FIG. 5 shows the air flow produced by the baffle system 36A and 36B for a printhead. The positive air flow exits the openings in the air baffle 36A adjacent to the printhead nozzle plate 38. The negative air flow being pulled by a negative air flow source through the negative air flow baffle 36B causes the air exiting air baffle 36A to flow across the nozzle plate 38 and sweep all of the sneeze drops being ejected from the printhead 34 as well as the satellite drops that break free of the sneeze drops into the openings of the negative air flow baffle 36B adjacent the nozzle plate 38. This air flow is parallel to the process direction P of the media passing the printhead 34. Before performing the sneeze operation, the controller 80 operates an actuator 40 to rotate a lead screw 42 to lift the printhead 38 away from the media path. This movement increases the distance between nozzle path and the media path to facilitate the formation of satellite drops from the sneeze drops and improve the efficiency of sweeping all of the ejected ink into the negative air flow baffle 36B. Once the sneeze operation is completed, the actuator 40 is operated to reverse the rotation of the screw 42 and return the printhead to its position for ink image formation on the passing media.

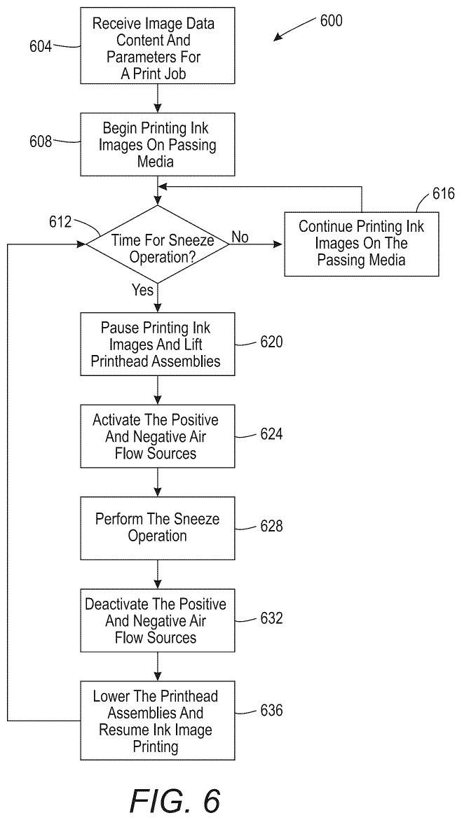

A process 600 for operating an inkjet printer configured with air baffles for the printheads in the printer is shown in FIG. 6. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 80 noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

The process 600 of FIG. 6 begins by receiving the ink image content data for a print job from either a scanning system or an online or work station connection (block 604). The ink image content data is processed to generate the inkjet ejector firing signals delivered to the printheads in the modules 34A-34D. Along with the ink image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “ink image content data” means digital data that identifies a color and a volume of each ejected ink drop that forms pixels in an ink image to be printed on a media sheet.

The process 600 receives the ink image content data and the print job parameters for the printing of the ink images of the print job on the media as the media passes the printhead assemblies (block 604). The ink image printing begins (block 608) and continues (blocks 612 and 616) until time for a sneeze operation is detected (block 612). The timing of a sneeze operation can be determined as the expiration of a predetermined time period, a counting of a predetermined number of media sheets, a calculation of a predetermined number of inkjets that have not been operated within a predetermined period of time, or a volume of ejected ink being less than a predetermined threshold over a predetermined time, or combinations of these methods. When a sneeze operation is to be performed, the ink image printing is paused and the printhead assemblies lifted (block 620). The positive and negative air flow sources are activated (block 624) and the sneeze operation is performed (block 624). The air flow sources are deactivated (block 628) at the conclusion of the sneeze operation, the printhead assemblies are lowered and the ink image printing resumes (block 632) until the conditions for the next sneeze operation occur. This process continues until the print job is concluded.

To retrofit a printer for operating the printer as described above with respect to FIG. 6, a kit containing two baffles 36A and 36B, a positive air source 304, a negative air source 312, and a U-shaped clip 32 can be provided for each printhead in a printer. Optionally, a humidifier 308 and a filter 316 can be provided for the two air baffles. For each printhead, a baffle is positioned on each side of the printhead and the U-shaped clip is positioned so each leg of the clip rests against the external surface of each baffle to compress the baffles against each printhead. The positive air source is coupled to an inlet of the baffle on the upstream side of the printhead in the process direction and the negative air source is coupled to the outlet of the baffle on the downstream side of the printhead in the process direction. Optionally, the humidifier can be installed in the air flow path between the positive air source and the air baffle on the upstream side and the filter can be installed in the air flow path between the negative air source and the air baffle on the downstream side. A non-transitory storage media on which programmed instructions are stored is operatively connected to the controller so the controller can execute the instructions for determining when to perform sneeze operations as described above, raise the printheads, operate the positive and negative air sources to sweep the nozzle plates of the printheads during sneeze operations and then return the printheads to their printing positions for further printing operations.

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. An inkjet printer comprising:
at least one printhead configured to eject drops of ink;
a conveyor configured to move media past the at least one printhead to receive ink drops ejected from the at least one printhead;
a first housing positioned on one side of the at least one printhead in a process direction, the first housing have a first opening and a second opening;
a second housing positioned on an opposite side of the at least one printhead in the process direction, the second housing have a first opening and a second opening;
a positive air flow source pneumatically coupled to the first opening of the first housing; and
a negative air flow source pneumatically coupled to the first opening of the second housing.

2. The inkjet printer of claim 1 further comprising:
at least one actuator configured to move the at least one printhead bidirectionally in a direction that is perpendicular to the conveyor.

3. The inkjet printer of claim 2 further comprising:
a humidifier pneumatically coupled to the inlet of the first housing between the positive air flow source and the inlet of the first housing.

4. The inkjet printer of claim 3, the humidifier being configured to generate solvent vapor.

5. The inkjet printer of claim 3, the humidifier being configured to generate water vapor.

6. The inkjet printer of claim 2 further comprising:
a filter pneumatically coupled to the inlet of the second housing between the negative air flow source and the inlet of the second housing.

7. The inkjet printer of claim 3 further comprising:
a filter pneumatically coupled to the inlet of the second housing between the negative air flow source and the inlet of the second housing.

8. The inkjet printer of claim 7 further comprising:
a controller operatively connected to the at least one printhead, the controller being configured to:
operate the at least one printhead to perform a sneeze operation.

9. The inkjet printer of claim 8, the controller being operatively connected to the at least one actuator, the controller being further configured to:
operate the at least one actuator to move the at least one printhead away from the conveyor in the direction perpendicular to the conveyor prior to operating the at least one printhead to perform the sneeze operation.

10. The inkjet printer of claim 9, the controller being further configured to:
operate the at least one actuator to move the at least one printhead toward the conveyor in the direction perpendicular to the conveyor after operating the at least one printhead to perform the sneeze operation.

11. A method of operating an inkjet printer comprising:
directing a positive air flow toward a conveyor moving media past at least one printhead in the inkjet printer, the positive air flow being on a first side of the at least one printhead in a process direction; and
pulling a negative air flow across a nozzle plate of the at least one printhead in the inkjet printer, the negative air flow being on a second side of the at least one printhead in the process direction that is opposite the first side of the printhead in the process direction.

12. The method of claim 11 further comprising:
operating at least one actuator to move the at least one printhead bidirectionally in a direction that is perpendicular to the conveyor.

13. The method of claim 12 further comprising:
directing humidified air into the positive air flow.

14. The method of claim 13 further comprising:
generating solvent vapor in the humidified air.

15. The method of claim 13 further comprising:
generating water vapor in the humidified air.

16. The method of claim 12 further comprising:
filtering the negative air flow.

17. The method of claim 13 further comprising:
filtering the negative air flow.

18. The method of claim 17 further comprising:
operating the at least one printhead to perform a sneeze operation.

19. The method of claim 18 further comprising:
operating the at least one actuator to move the at least one printhead away from the conveyor in the direction perpendicular to the conveyor prior to operating the at least one printhead to perform the sneeze operation.

20. The method of claim 19 further comprising:
operating the at least one actuator to move the at least one printhead toward the conveyor in the direction perpendicular to the conveyor after operating the at least one printhead to perform the sneeze operation.

21. A kit for retroactively modifying an inkjet printer to sweep a nozzle plate of a printhead in the inkjet printer during sneeze operations comprising:
a first air baffle;
a second air baffle;
a clip configured to hold the first air baffle and the second air baffle against opposite sides of a printhead in the inkjet printer;
a positive air flow source configured to be pneumatically coupled to the first air baffle; and
a negative air flow source configured to be pneumatically coupled to the second air baffle.

22. The kit of claim 21 further comprising:
a humidifier configured to be pneumatically coupled in an air flow path between the first air baffle and the positive air flow source.

23. The kit of claim 22, the humidifier being configured to generate solvent vapor.

24. The kit of claim 23, the humidifier being configured to generate water vapor.

25. The kit of claim 22 further comprising:
a filter configured to be pneumatically coupled in an air flow path between the second baffle and the negative air flow source.

26. The kit of claim 23 further comprising:
a filter to be pneumatically coupled in an air flow path between the second baffle and the negative air flow source.

27. The kit of claim 26 further comprising:
a non-transitory storage media configured to store programmed instructions that cause a controller of the inkjet printer, when the programmed instructions are executed by the controller, to:
operate the printhead between the first air baffle and the second air baffle to perform a sneeze operation.

28. The kit of claim 27, the programmed instructions causing the controller, when the programmed instructions are executed, to:
operate at least one actuator in the inkjet printer to move the printhead between the first air baffle and the second air baffle away from a conveyor in the inkjet printer in a direction perpendicular to the conveyor prior to operating the printhead between the first air baffle and the second air baffle to perform the sneeze operation.

29. The kit of claim 28, the programmed instructions causing the controller, when the programmed instructions are executed, to:
operate the at least one actuator to move the printhead between the first air baffle and the second air baffle toward the conveyor in the direction perpendicular to the conveyor after operating the at least one printhead to perform the sneeze operation.
